(19) United States
(12) Patent Application Publication
(10) Pub. No.: US 2026/0097558 A1
(43) Pub. Date: Apr. 9, 2026

(54) METHOD AND APPARATUS FOR MANUFACTURING ULTRA-HIGH MOLECULAR WEIGHT POLYETHYLENE STRUCTURES INCORPORATING GRAPHENE

(71) Applicant: Vikela Armour Limited, Quaygate, Belfast, County Antrim (GB)

(72) Inventor: Peter Gilleece, Belfast, County Antrim (GB)

(21) Appl. No.: 19/123,671

(22) PCT Filed: Oct. 18, 2023
(86) PCT No.: PCT/EP2023/078935

§ 371 Date: Apr. 23, 2025

(30) Foreign Application Priority Data
Oct. 24, 2022 (GB) 2215699.6

(51) Int. Cl. B29C 64/153; B29C 64/218; B29C 64/25; B29C 64/268; B29C 64/277; B29C 64/295; B29C 64/329; B29C 64/371; B29K 23/00; B29K 105/00; B29K 507/04

(52) U.S. Cl. CPC B29C 64/153; B29C 64/218; B29C 64/25; B29C 64/268; B29C 64/277; B29C 64/295; B29C 64/329; B29C 64/371; B29K 2023/0683; B29K 2105/251; B29K 2507/04

(57) ABSTRACT

A method and apparatus are provided for manufacturing UHMWPE structures incorporating graphene in a build chamber with a moveable platform defining a build plate on which a powder material may be sintered, layer-by-layer, in a SLS 3D printing process. The build chamber may be pre-heated and pressure within the chamber reduced and/or an inert gas supplied to the chamber. A layer of UHMWPE powder is deposited onto the build plate to define a print bed. Selected regions of the powder layer are exposed to at least a first laser source to create sintered regions of the powder, and selected regions of the powder layer are exposed to at least a second laser source to form graphene derived from the powder. The platform may then be lowered a step corresponding to the thickness of the powder layer, followed by depositing another layer of UHMWPE powder thereon, and steps repeated as needed.

### CROSS REFERENCE TO RELATED APPLICATIONS

This present application is a § 371 national stage of International Application PCT/EP2023/078935, filed Oct. 18, 2023 which claims priority benefit of U.K. Pat. Application Ser. No. 2215699.6, filed Oct. 24, 2022, both of which are hereby incorporated herein by reference in their entireties.

### FIELD

This disclosure relates to a method and apparatus for manufacturing UHMWPE structures incorporating graphene using an additive manufacturing technique, such as for manufacturing improved body armour.

### BACKGROUND

Ultra-high molecular weight polyethylene (UHMWPE) is a high performance polymer having a low coefficient of friction, very good abrasion resistance, high toughness and impact resistance, as well as high chemical resistance and good biocompatibility. It is used in shipbuilding, textile industries and also in biomedical applications. It has also been found to provide advantageous properties when used to manufacture body armour due to its light weight and good ballistic resistance.

However, UHMWPE parts cannot be produced easily by traditional plastics manufacturing techniques, such as injection moulding or extrusion, because of its very high melt viscosity owing to the extremely long polymer chains.

Selective laser sintering (SLS) is an additive manufacturing technique that uses a laser as the power and heat source to sinter powdered material (typically nylon or polyamide). The laser is aimed at points in subsequent layers of the powdered material upon a print bed, at locations defined by a 3D model, to bind the material together, layer by layer, to create a solid structure. There are difficulties of processing UHMWPE using SLS techniques due to its transparency and highly agglomerated structure, leading to high porosity and poor material consistency in the finished products and the inability to create a thin sheet for flexible circuitry.

Also, while UHMWPE provides good ballistic resistance, UHMWPE body amour is generally unable to stop bullets from high calibre weapons without requiring excessive thickness.

### SUMMARY

According to a first aspect, a method of manufacturing UHMWPE structures incorporating graphene includes the steps of:
i. providing a build chamber having a vertically moveable platform defining a build plate upon which a powder material may be sintered layer by layer in a SLS 3D printing process;
ii. pre-heating the build chamber;
iii. reducing the pressure within the build chamber and/or supplying an inert gas into the build chamber;
iv. depositing a layer of UHMWPE powder onto the build plate to define a print bed;
v. exposing selected regions of the layer of UHMWPE powder to at least one first laser source to create sintered regions of the layer of UHMWPE powder;
vi. exposing selected regions of the sintered regions of UHMWPE powder to at least one second laser source resulting in the formation of graphene derived from the UHMWPE powder;
vii. lowering the platform one step corresponding to the thickness of the layer of UHMWPE powder and depositing a further layer of UHMWPE powder thereon;
viii. repeating steps (v) to (vii) until the structure is completed.

In one embodiment the at least one first laser source comprises an unfocussed IR laser source spread across the selected regions of the layer of UHMWPE powder and one or more focused UV lasers adapted to sinter outlines and or details of the selected regions of the layer of UHMWPE powder.

The second laser source may comprise one or more focused UV lasers adapted to induce the formation of graphene on selected regions of the print bed.

The method may further comprise the further step of pressing the layer of UHMWPE powder deposited onto the build plate after exposing the selected regions of the layer to at least one first laser source. The layer of UHMWPE may be pressed using a heated roller adapted to traverse over the build plate.

The method may further comprise the step of detecting localised downward displacement of the heated roller during movement of the roller over the print bed and subsequently adding additional powder and optionally repeating sintering to regions wherein displacement of the heated roller indicates the presence of voids in the layer of UHMWPE before repeating the step of traversing the heated roller over the print bed.

Optionally, the method comprises the step of pre-heating the build chamber in a separate pre-heating chamber before transferring the build chamber into a printer housing containing the first and second laser sources. The method may comprise the further step of transferring the build chamber into a second chamber after completion of the structure and allowing the build chamber to cool within the second chamber. The pre-heating chamber, second chamber and the printer housing may include co-operating openable doors to allow transfer of the build chamber therebetween while maintaining a reduced pressure and/or inert gas atmosphere within the pre-heating chamber, the second chamber and the printer housing.

According to a further aspect there is provided an apparatus for manufacturing UHMWPE structures incorporating graphene comprising:
a build chamber having a vertically moveable platform defining a build plate upon which a powder material may be sintered layer by layer in a SLS 3D printing process;
a printer housing within which the build chamber may be enclosed;
the housing incorporating a heater or heating means for heating the build chamber;
a pressure-reducer or means for reducing the pressure within the housing and/or an inert gas supply or means for supplying an inert gas into the housing;
a powder supply system adapted to deposit layers of UHMWPE powder onto the build plate;
a first laser system adapted to sinter selected regions of an uppermost layer of UHMWPE powder defining a print bed on the build plate of the build chamber; and
a second laser system adapted to induce the formation of graphene on the print bed.

The at least one first laser source may comprise an unfocussed IR laser source spread across the selected regions of the layer of UHMWPE powder and one or more focused UV lasers adapted to sinter outlines and or details of the selected regions of the layer of UHMWPE powder.

The second laser source may comprise one or more focused UV lasers adapted to induce the formation of graphene on selected regions of the print bed.

The powder supply system may comprise a powder storage hopper mounted on a gantry within the housing and above the build plate. A dosing wheel may be coupled to an outlet of the powder storage hopper in the top of the housing for metering the flow of powder from the lower end of the hopper. The powder storage hopper may be adapted to be moved in a line parallel to the build plate, while operating the dosing wheel, thereby depositing a trail of powder adjacent to the build plate. Optionally, a roller is mounted in the housing to be traversed over the print bed to spread the trail of powder across the print bed. The roller may include a heater or heating means for heating the outer surface of the roller.

The roller may be adapted to be pressed down against the print bed as it traverses the print bed, such that the roller may be passed over each freshly sintered layer on the print bed, pressing down onto the layer, to ensure sufficient adhesion between layers as well as reduce porosity of the sintered structure.

Optionally, the roller includes a displacement detector or means for detecting localised downward displacement of the roller during movement of the roller over the print bed following sintering of the powder thereon, the detector or detecting means providing feedback to control system of the apparatus, wherein the control system is adapted to add additional powder and optionally repeating sintering of regions wherein displacement of the heated roller indicates the presence of voids and/or incomplete sintering in the layer of UHMWPE before repeating the step of traversing the roller over the print bed.

The control system may be programmed to scan the surface of the material upon the print bed when deflection of the roller indicates the presence of voids and/or incomplete sintering in the layer of UHMWPE, to thereby determine which areas have been correctly sintered and which have not, a further layer of powder then being spread over the print bed without the build plate moving down to start the next layer and a further sintering process is repeated with a focus given to thus identified poorly sintered area. The control system may be programmed to, after the further sintering step has been completed, scan the surface again to thereby determine if any areas remain which have been incorrectly sintered, in which case the control system will cause the roller will be traversed over the print bed again, applying further pressure to the structure to adhere the layers, and this process may repeat until the feedback mechanism deems that the sintering is satisfactory.

The apparatus may further comprise a pre-heating chamber within the build chamber may be pre-heated before being transferred into the printer housing containing the first and second laser sources. A second chamber may be provided into which the build chamber can be transferred to be cooled therein after completion of the structure in the printer housing. The second chamber may comprise a second pre-heating chamber. Optionally, the pre-heating chamber and second chamber are adapted to be portable and to be moved with respect to the printer housing. The pre-heating chamber, second chamber and the printer housing may include co-operating openable doors to allow transfer of the build chamber therebetween while maintaining a reduced pressure and/or inert gas atmosphere within the pre-heating chamber, the second chamber and the printer housing.

These and other objects, advantages, purposes and features of the present disclosure will become apparent upon review of the following specification in conjunction with the drawings.

### BRIEF DESCRIPTION OF THE DRAWINGS

An apparatus for manufacturing UHMWPE structures incorporating graphene in accordance with an embodiment of the present invention will now be described, by way of example only, with reference to the accompanying drawings, in which:

FIG. 1 is a perspective view of a 3D printing apparatus for manufacturing UHMWPE structures incorporating graphene in accordance with an embodiment;

FIG. 2 is a sectional view through the apparatus of FIG. 1;

FIG. 3 is a detailed view of region A of FIG. 2;

FIG. 4 is a schematic view of the laser assembly of the apparatus of FIG. 1;

FIG. 5 is a detailed schematic view of the mirror system for the IR laser of the laser assembly of FIG. 5;

FIG. 6 is a further schematic view of the IR laser system of the laser assembly of FIG. 4; and

FIG. 7 is a schematic view of the UV sintering lasers of the laser assembly of FIG. 4.

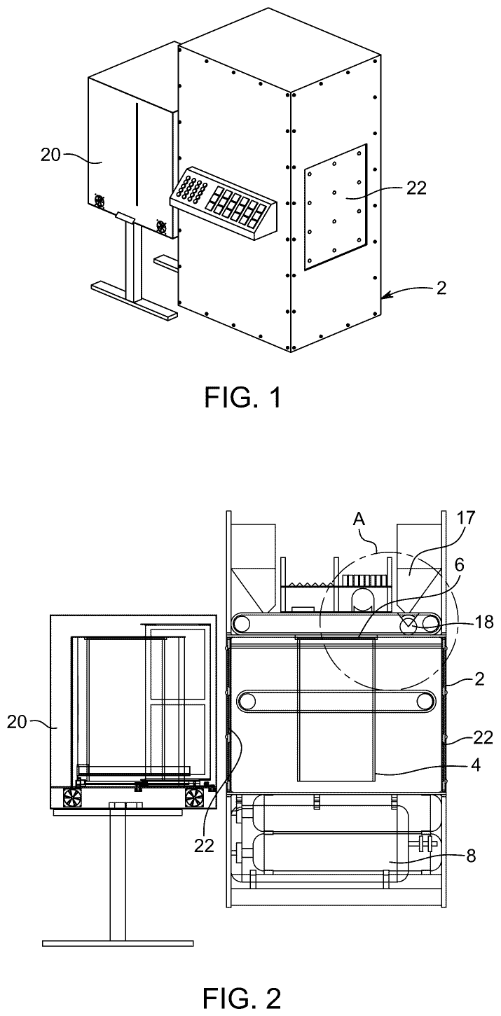

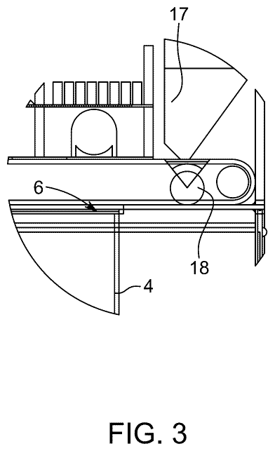

### DETAILED DESCRIPTION

As shown in the drawings, an apparatus for manufacturing UHMWPE structures incorporating graphene in accordance with an embodiment comprises a hermetically sealed printer housing 2 adapted to be filled with an inert gas, such as Nitrogen, and within which can be located a build chamber 4.

A print bed 6 is defined on top of a vertically moveable platform inside of the build chamber 4, the platform defining a build plate upon which the structure is created within the build chamber, layer by layer, by means of a selective laser sintering (SLS) 3D printing process. A powder supply system 10 is provided within the housing and above the build chamber 4 for delivering layers of UHMWPE powder onto the print bed 6 of the build chamber.

A heater or heating means (not shown) are provided within the printer housing 2 to heat and maintain the temperature of the build chamber 4 at a temperature just below the melting point of the powder. Liquid Nitrogen storage tanks 8 may be located in a lower region of the printer housing 2.

A laser assembly is mounted in an upper part of the printer housing 2, above the build chamber 4, the laser assembly including first laser system being adapted to heat selected regions of the uppermost layer of powder on the print bed 6 to just below or right at the melting point of the material, thereby fusing (sintering) the particles in the selected regions of the uppermost layer of the powder together and to the already sintered material in the layers below. The unfused powder supports the sintered structure during printing and eliminates the need for dedicated support structures.

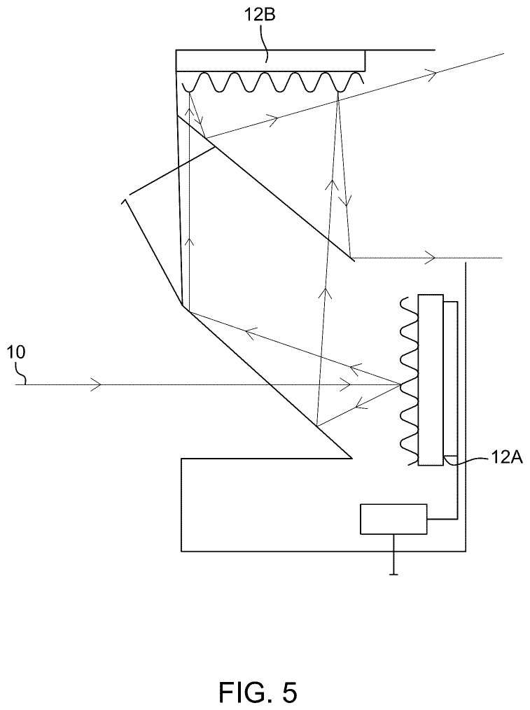

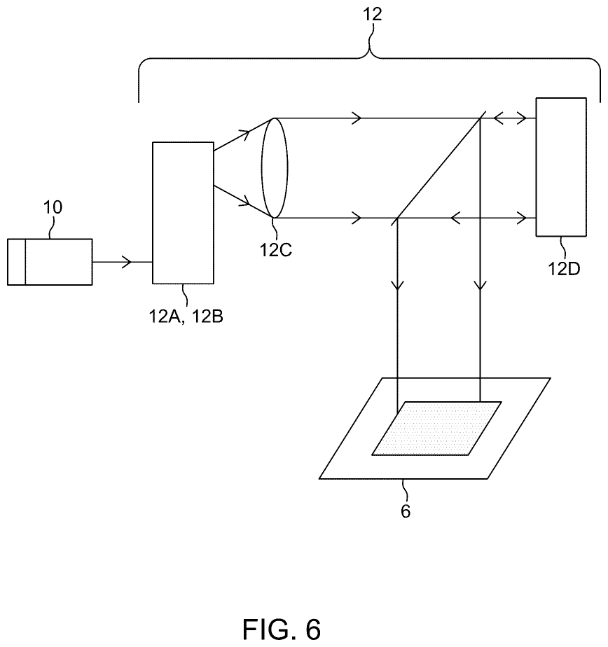

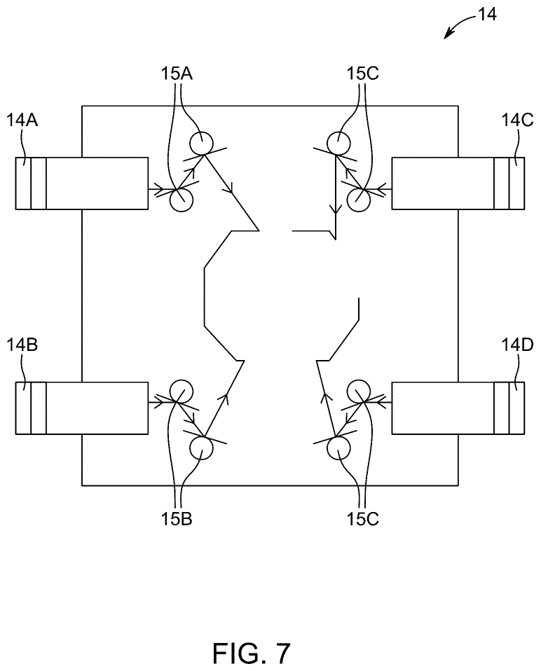

In the illustrated embodiment the first laser system includes an infra-red (IR) laser 10, the output of which is reflected and pulsed, but not focused, via suitable mirrors and lenses 12, onto the uppermost layer of powder on the print bed so that it covers a two dimensional area over the print bed. As illustrated in FIG. 5, the IR laser 10 may be pulsed between 1 Hz and 1 GHz onto a first sine wave shaped mirror 12A adapted to be moved slowly across the beam in the same direction as the waves in the mirror. After the laser pulses have been reflected by the first mirror 12A they may be directed towards a second, stationary sinusoidal mirror 12B arranged at 90°to the first mirror 12A. This reflects the laser pulses into a one dimensional line capable of being scanned over the print bed 6. As illustrated in FIG. 6, this path of pulses is directed through a series of lenses 12C onto a liquid crystal on silicon (LCOS) screen 12D. This screen 12D will display the pattern desired for this specific layer of printing and reflect only the pulses in these regions. This reflection is then directed onto the print bed 6, sintering a portion of the uppermost layer of powder thereon determined by the pattern on the LCOS screen. This process sinters the powder to define the main body of the desired shape.

The IR laser 10 may comprise a 100 w CO₂ laser pulsed between 1 Hz and 1 Ghz and slightly defocused to spread the beam size to be approximately 1 mm wide through a series of glass lenses. The beam is then directed at the first sinusoidal holographic mirror 12A (wavelength of 10 micrometres) which is moved parallel to the wave in the mirror at a constant speed of 1 mm per second. After the laser pulses have been reflected by this mirror they are directed towards the second sinusoidal mirror 12B arranged at 90° to the first mirror. This arrangement may advantageously spread the laser pulses from a fixed point of approximately 1 mm to a series of random points in an area of approximately 330 mm×330 mm. With the variable pulse rate, the IR laser can be controlled to hit substantially all of a selected area of the print bed 6 at least once to ensure that the whole layer of powder in the selected area has been sintered. After being been reflected from the secondary mirror, the pulses are directed to the LCOS screen 12D which will display only the selected area on the print bed 6 that is desired for sintering. This ensures that only pulses in this area are reflected onto the print bed 6 and that the correct area is sintered.

The first laser system may further include a separate ultra violet laser system 14 provided to more accurately create fine detail in the structure (e.g. the edges of the desired structure). In one embodiment four UV lasers 14A,14B,14C,14D may be provided, each one emitting a focused beam directed onto a respective pair of rotating mirrors 15A,15B,15C,15D, one mirror of each pair rotating in the x plane and the other mirror in each pair rotating in the y plane, thereby allowing the focused beam from each UV laser 14A,14B,14C,14D to be directed at any point in a respective assigned quarter of the print bed 6. This allows accurate edges of the structure to be sintered.

The combination of both pulse sintering (IR laser 10) and cold processing (UV lasers 14) enables the accurate creation of complex shapes at very high speeds.

The UV lasers 14A,14B,14C,14D may each comprise an Excimer laser XeF (xenon fluoride) 351 nm laser. A UV laser reacts with materials very differently than an IR laser because it does not heat the material to melt it. Instead, a UV laser imparts a very precise and localised amount of energy to break and reform bonds in the material.

By using four of these UV lasers to sinter the edges of the structure in a given layer of powder, one for each quadrant of the build plate, each laser can easily cover the entire area of its quadrant and effectively can “draw” around the edges of the shape of the structure to be created with great accuracy.

The apparatus includes a second laser system to induce the formation of graphene in selected layers of the sintered powder on the print bed 6, when it is desired to incorporate graphene material into the finished structure, a graphene being derived from the UHMWPE powder by a laser induced graphene (LIG) process.

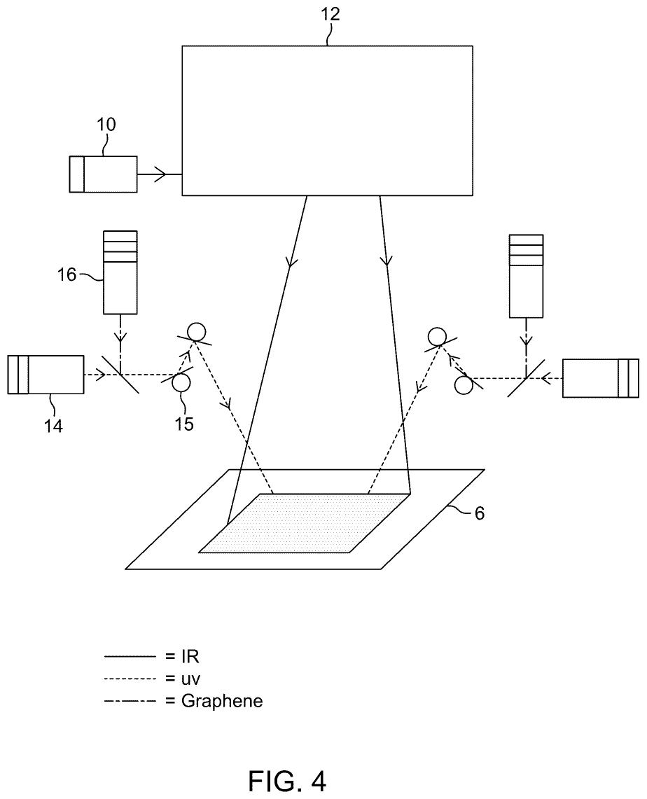

The second laser system may comprise an further arrangement of UV lasers and mirrors having a structural arrangement to the UV lasers of the first laser system, the second laser system comprising four UV lasers 16, each covering a quarter of the print bed 6. The lasers are each directed using x and y moveable mirrors so that each laser beam can be directed as needed. The lasers in the second laser system may comprise KrF (krypton fluoride) 248 nm lasers. The output from these lasers will be directed over the already sintered material to produce the required shape of graphene. This can be to cover the whole of the already sintered material in the layer or it can be to only cover part of the sintered layer in any desired shape and anything in between. As illustrated in FIG. 4, the UV sintering lasers 14 and the UV graphene lasers 16 may be associated with a common set of optics and rotating mirrors for directing the resulting beams at the print bed 6.

After sintering of the powder in the uppermost layer and optionally the formation of graphene in selected regions thereof, the platform then lowers by one layer into the build chamber, typically a distance of between 50 to 200 microns, and a further layer of powder is deposited on top of the build plate and the process repeats.

In the embodiment shown in the drawings, the powder supply system 10 comprises a powder storage hopper provided in an upper part of the build chamber adapted to deliver thin layers of powder onto the print bed.

Most known SLS printers feed powder to the build plate by providing a powder storage chamber, of a similar size to the build chamber, alongside the build plate. A piston from below lifts the powder level in the powder storage chamber to be just above the level of the build plate and a roller is used to spread a layer of this powder across the build plate from the powder storage chamber. However, this system requires the powder storage chamber to be located adjacent to the build chamber, significantly increase the printer's footprint as well as increasing the complexity of system maintenance.

This problem can be solved by providing the powder storage hopper 17 on a gantry within the housing and above the build plate. A dosing wheel may be coupled to an outlet of the powder storage hopper in the top of the housing for metering the flow of powder from the lower end of the hopper.

Once filled, the powder storage hopper is adapted to be moved in a line parallel to the build plate, while operating the dosing wheel, thereby depositing a trail of powder adjacent to the build plate. A roller 18 may be provided for spreading this trail of powder across the print bed 6. While this powder supply system requires a dosing wheel and a precise control system to ensure an even spread of powder across the build plate, it significantly reduces the footprint of the printer as well as simplifying the powder storage.

A state above, a roller 18 is provided to move the powder across the print bed 6. The roller 18 may be formed from a metal and optionally heated internally. The roller 18 may be motor driven for movement back and forward across the build plate. Extra actuators or motors, one at each end of the roller 18, may be provided to press the roller 18 down against the build plate, creating a pressure on each layer of powder.

The roller 18 may serve multiple functions.

As stated above, the roller 18 is firstly used to spread a layer of the powder across the print bed 6 prior to sintering of the layer.

The secondary function of the roller 18 may be utilised after each layer of powder has been sintered. In such secondary function, the heated roller 18 may be passed over each freshly sintered layer on the print bed, pressing down onto the layer, such as with a pressure between 0.5 and 6 bar. The purpose of this is to ensure sufficient adhesion between layers as well as reduce porosity of the sintered structure.

The roller 18 may also be associated a feedback mechanism, including a displacement detector or means for detecting vertical displacement of the roller towards the build plate. This feedback mechanism may facilitate the determination of excessive porosity in the sintered structure and/or if the layers of the structure have not been fused properly. The detection of localised downward displacement of the roller as it traverses the print bed may provide an indication of a region of the layer having poor porosity or bad sintering. When this is detected, the roller 18 may be moved to the side of the print bed and the surface of the material upon the print bed may be scanned, for example using Lidar, to determine which areas of the part have been correctly sintered and which have not. Once this has been established by the scanning step, a further layer of powder may be spread over the print bed, using the roller 18, without the build plate moving down to start the next layer. The laser sintering process may then repeat with a focus given to the poorly sintered area. After this laser sintering step has been completed, the surface may be scanned again. If the problem is still there, then the roller will be traversed over the print bed again, applying further pressure to the structure to adhere the layers, and this process may repeat until the feedback mechanism deems that the sintering is satisfactory.

If the feedback mechanism, in particular the scanning step, determines that the sintering has been successful, it may be determined that the problem detected by displacement is layer adhesion and/or porosity further down in the structure. In such event, the roller may be operated to apply greater pressure against the print bed and complete more traverses over the print bed until the feedback mechanism determines that the pressure applied by the roller across the structure on the build plate is even. At this point the build plate can be moved down one step and the formation of the next layer can begin.

Most SLS printers utilise a manual system for build chamber movement through the printer. These systems typically require the build chamber to be manually placed into the printer through a front facing door where it will remain stationary for the duration of the heating, printing and a subsequent cooling process. The benefit of such known systems is that the manual movements simplify the mechanisms inside the printer as no moving parts are required to assist in the locating of the print bed relative to the sintering laser footprint, thereby allowing for accurate and repeatable prints. This lack of additional mechanism also lowers the overall footprint and cost of the total printer.

The main disadvantage of such known SLS printers is the requirement for the build chamber 4 to be stationary within the printer during heating and cooling to ensure even cooling of the sintered structure produced and thus prevent deformation of the thus formed structure. With large prints taking up to twenty four hours this can lead to heating times of over an hour and cooling times of over ten hours for a typical print, resulting in an up to 50% downtime for a printer.

Some known systems have attempted to solve this issue by creating a larger internal chamber within the printer to allow for multiple chambers to be stored at once and thus multiple chambers to be printed on in sequence, thereby reducing the downtime of the machine. However, this significantly increases the footprint of the printer as well as increasing the amount of power required to heat the now larger internal volume of the machine.

This problem can be solved by heating and cooling each build chamber in a separate and portable pre-heating chamber 20, outside of the printer housing. This pre-heating chamber may be separate from the printer housing 2 of the apparatus and may adapted to be coupled to the main printer housing 2, whereby a pre-heated build chamber 4 can be moved from the pre-heating chamber 20 and into and out of the housing 2 through cooperating insulated doors 22 provided in one or both sides of the housing (such as via an inlet side and an exit side) and a cooperating side of the pre-heating chamber 20, such that the printing/sintering process can start immediately.

Once the pre-heated build chamber 4 is transferred into the printer housing 2 from the pre-heating chamber 20, the respective doors 22 can be closed and sealed. A second pre-heating chamber 20 may be located on an opposite side of the housing 2 adjacent an exit door of the housing 2 where the same process may happen to transfer the build chamber 4 presently within the housing 2, containing the completed print/structure, into the second pre-heating chamber, wherein the build chamber can be allowed to cool slowly without requiring it to remain in the main printer housing during such cooling process, significantly reducing the machines downtime.

The pre-heating chamber 20 may be adapted to pre-heat the build chamber 4 as well as be filled with an inert gas, such as nitrogen. This may allow a pre-heated build chamber ready to be moved into the main housing and for printing/sintering to start as soon as the previous print is complete and removed from the main housing into a further portable pre-heating chamber, massively speed up manufacturing times by reducing downtime. All of these processes repeat until the print has finished at which point the exit area door will open and the build chamber will be moved into its own section for cooling and depressurisation. The new empty build chamber will then move into the build area.

The powder used in the apparatus will comprise ultra-high molecular weight polyethylene (UHMWPE) as its base polymer. This is an unusual material to use for SLS printing due to it being colourless and having a low melting point. Most polymers used in SLS printing are dark or black in colour, for example nylon 11. This is because it absorbs the laser much better allowing for an easier sintering process. As UHMWPE is colourless, this can make it difficult to sinter. It is also difficult to sinter without completely melting the material as the melting point is so low (130° C. to 136° C.). These factors make it a poor choice for SLS 3D printing and thus is often disregarded as a polymer for this process.

The disclosed embodiments overcome these issues by defocusing an IR laser beam used for sintering. This uses the same energy, but over a much wider area, keeping the material from melting completely. This laser is used over most of the bulk of the part. This process is to gently nudge the material so that it is forming bonds between the particles of the powder. Due to the heated environment within the build chamber, the material is near its melting point and just needs a small bit of additional energy to begin boding between the particles of the powder.

If desired, after the layer has been sintered it can be treated to form graphene. This process involves scribing a second laser system over the desired area in order to remove the hydrogen atoms from the UHMWPE, leaving just the carbon. The energy from the laser forces these carbon atoms to then bond together forming a sheet of graphene covering all of the desired area of the print bed.

The apparatus described above may advantageously be used to manufacture body armour, wherein graphene sheets can be integrated into the UHMWPE structure to improve the ballistic performance of the body armour. It is also envisaged that the apparatus can be used to manufacture numerous other UHMWPE products that may benefit from the incorporation of graphene embedded within the structure to provide enhanced mechanical and/or electrical properties.

The invention is not limited to the embodiment described herein but can be amended or modified without departing from the scope of the present invention as defined by the appended claims as interpreted according to the principles of patent law including the doctrine of equivalents.

1. A method of manufacturing an ultra-high molecular weight polyethylene (UHMWPE) structure incorporating graphene, said method comprising the steps of:
i. providing a build chamber having a vertically moveable platform defining a build plate upon which a powder material may be sintered layer by layer in a selective laser sintering (SLS) 3D printing process;
ii. pre-heating the build chamber;
iii. reducing the pressure within the build chamber and/or supplying an inert gas into the build chamber;
iv. depositing a layer of UHMWPE powder onto the build plate to define a print bed;
v. exposing selected regions of the layer of UHMWPE powder to at least one first laser source to create sintered regions of the layer of UHMWPE powder;
vi. exposing selected regions of the sintered regions of UHMWPE powder to at least one second laser source resulting in the formation of graphene derived from the UHMWPE powder;
vii. lowering the platform one step corresponding to the thickness of the layer of UHMWPE powder and depositing a further layer of UHMWPE powder thereon;
viii. repeating steps (v) to (vii) until the structure is completed.

2. The method of claim 1, wherein the at least one first laser source comprises an unfocussed IR laser source spread across the selected regions of the layer of UHMWPE powder and one or more focused UV lasers adapted to sinter outlines and or details of the selected regions of the layer of UHMWPE powder.

3. The method of claim 1, wherein the second laser source comprises one or more focused UV lasers adapted to induce the formation of graphene on selected regions of the print bed.

4. The method of claim 1, comprising the further step of pressing the layer of UHMWPE powder deposited onto the build plate after exposing the selected regions of the layer to the at least one first laser source.

5. The method of claim 4, wherein the layer of UHMWPE is pressed using a heated roller adapted to traverse over the build plate.

6. The method of claim 5, comprising the step of detecting localised downward displacement of the heated roller during movement of the roller over the print bed and subsequently adding additional powder and optionally repeating sintering to regions wherein displacement of the heated roller indicates the presence of voids in the layer of UHMWPE before repeating said step of traversing the heated roller over the print bed.

7. The method of claim 1, comprising the step of pre-heating the build chamber in a separate pre-heating chamber before transferring the build chamber into a printer housing containing the first and second laser sources.

8. The method of claim 7, comprising the step of transferring the build chamber into a second chamber after completion of the structure and allowing the build chamber to cool within the second chamber.

9. The method of claim 7, wherein the pre-heating chamber, second chamber and the printer housing include co-operating openable doors to allow transfer of the build chamber therebetween while maintaining a reduced pressure and/or inert gas atmosphere within the pre-heating chamber, the second chamber and said the printer housing.

10. An apparatus for manufacturing an ultra-high molecular weight polyethylene (UHMWPE) structure incorporating graphene, said apparatus comprising:
a build chamber having a vertically moveable platform defining a build plate upon which a powder material may be sintered layer by layer in a selective laser sintering (SLS) 3D printing process;
a housing within which said build chamber may be enclosed;
said housing incorporating a heater for heating said build chamber;
a pressure-reducer for reducing the pressure within said housing and/or an inert gas supply operable to supply an inert gas into said housing;
a powder supply system adapted to deposit layers of UHMWPE powder onto said build plate;
a first laser system adapted to sinter selected regions of an uppermost layer of UHMWPE powder defining a print bed on said build plate of said build chamber; and
a second laser system adapted to induce the formation of graphene on said print bed.

11. The apparatus of claim 10, wherein said at least one first laser source comprises an unfocussed IR laser source spread across the selected regions of the layer of UHMWPE powder and one or more focused UV lasers adapted to sinter outlines and or details of the selected regions of the layer of UHMWPE powder.

12. The apparatus of claim 10, wherein said second laser source comprises one or more focused UV lasers adapted to induce the formation of graphene on selected regions of said print bed.

13. The apparatus of claim 10, wherein said powder supply system comprises a powder storage hopper mounted on a gantry within said housing and above said build plate.

14. The apparatus of claim 13, further comprising a dosing wheel is coupled to an outlet of said powder storage hopper in the top of said housing for metering the flow of powder from the lower end of said hopper.

15. The apparatus of claim 14, wherein said powder storage hopper is adapted to be moved in a line parallel to said build plate, while operating said dosing wheel, thereby depositing a trail of powder adjacent to said build plate.

16. The apparatus of claim 15, wherein a roller is mounted in said housing and operable to traverse over said print bed to spread the trail of powder across said print bed.

17. The apparatus of claim 16, wherein said roller includes a heater for heating an outer surface of said roller.

18. The apparatus of claim 17, wherein said roller is adapted to be pressed down against said print bed as it traverses said print bed, such that said roller may be passed over each freshly sintered layer on said print bed, pressing down onto the layer, to ensure sufficient adhesion between layers as well as reduce porosity of the sintered structure.

19. The apparatus of claim 18, wherein said roller includes a detector for detecting localised downward displacement of said roller during movement of said roller over said print bed following sintering of the powder thereon, said detector providing feedback to control system of said apparatus, wherein said control system is adapted to add additional powder and repeating sintering of regions wherein displacement of said heated roller indicates the presence of voids and/or incomplete sintering in the layer of UHMWPE before repeating the step of traversing said roller over said print bed.

20. The apparatus-as of claim 19, wherein said control system is programmed to scan the surface of the material upon said print bed when deflection of said roller indicates the presence of voids and/or incomplete sintering in the layer of UHMWPE, to thereby determine which areas have been correctly sintered and which have not, a further layer of powder then being spread over said print bed without said build plate moving down to start the next layer and a further sintering process is repeated with a focus given to thus identified poorly sintered area.

21. The apparatus of claim 20, wherein said control system is programmed to, after the further sintering step has been completed, scan the surface again to thereby determine if any areas remain which have been incorrectly sintered, in which case said control system will cause said roller will be traversed over said print bed again, applying further pressure to the structure to adhere the layers, and this process is repeatable until said feedback mechanism deems that the sintering is satisfactory.

22. The apparatus of claim 10, further comprising a pre-heating chamber within said build chamber may be pre-heated before being transferred into said printer housing containing said first and second laser sources.

23. The apparatus of claim 22, further comprising a second chamber into which said build chamber can be transferred to be cooled therein after completion of the structure in said printer housing.

24. The apparatus of claim 23, wherein said pre-heating chamber, said second chamber and said printer housing include co-operating openable doors to allow transfer of said build chamber therebetween while maintaining a reduced pressure and/or inert gas atmosphere within said pre-heating chamber, said second chamber and said printer housing.
